(19) United States
(12) Patent Application Publication
(10) Pub. No.: US 2003/0047040 A1
(43) Pub. Date: Mar. 13, 2003

(54) Washer holder and insertion tool

(76) Inventor: Lyle Goskesen, Austin, MN (US)

Correspondence Address: William C Flynn, Attorney at Law, P.O. BOX 74, Chanhassen, MN, 55317, US

(21) Appl. No.: 10/225,009

(22) Filed: Aug. 21, 2002

Related U.S. Application Data
(60) Provisional application No. 60/313,955, filed on Aug. 21, 2001.

(51) Int. Cl. B25B 9/00

(52) U.S. Cl. 81/13

(57) ABSTRACT

A tool for selectively holding standard sized washers having a handle having a first end, the first end having a pair of facing ears formed facingly thereon the facing ears having a partial slightly more than a semi-circular inner periphery sized to matingly abut the outer periphery of a standard sized washer; the handle first end further having a relief slot formed between the ears, the relief slot extending along the handle from the first end, the handle further having a thickness approximating the thickness of the standard sized washer.

This application has a priority based on a previously filed provisional patent application titled Washer holder and Insertion Tool filed Aug. 21, 2001 and having Ser. No. 60/313,955.

### BACKGROUND OF THE INVENTION

The construction and maintenance of aircraft requires a high degree of precision and accuracy. While a great degree of precision can be achieved, perfection cannot. Often, spacers or washers become necessary to both compensate for small variances occurring in portions of the airframe or to provide the ability to make adjustments at the time of assembly or repair for correcting discrepancies or for adjusting alignment of parts in an airframe.

It is necessary that the parts be assembled to very close tolerances, frequently in confined spaces. One example of close tolerances involves the use of special high precision washers, referred to in the industry as “Army and Navy” washers or “AN” washers. The term AN washer describes a special classification of washers that are constructed to very close tolerances and are available in standard diameters and thicknesses. Most often the thickness of an AN washer is either “thin” which is approximately 0.039 inch, or “thick” which is approximately 0.049 inch. While the AN washers are available in other thicknesses, the thin and thick thicknesses are the most commonly available and used sizes.

Recently, the specification for the washers has been renamed and renumbered. The new term used is National Aerospace Standards or “NAS” washers. The NAS specification has also changed the names of the thicknesses so that an AN thin washer is now a NAS “light” or “L” washer. Likewise, the AN thick washer is now the NAS “standard” or “S” washer. Both nomenclatures are presently in common usage and for convenience, this application will retain the older terminology. It is therefore understood that a reference to “AN” washers includes reference to “NAS” washers. References to the AN term “thin” also includes reference to NAS term “light.” Reference to the AN term “thick” also includes reference to the NAS term “standard.”

The AN washers are used both as spacers and as gaskets in the fabrication of aircraft. When used as a spacer between two parts that are being joined using a threaded fastener such as a bolt, the AN washer serves to either fill a space, or provide alignment between the two parts. Thus, a threaded bolt or other fastener is passed through the first part and thence through the AN washer and into the second part where the threaded portion of the bolt is secured by mating threads in either the second part or a nut.

When the AN washer is used as a gasket, the washer generally is used in the same manner, but, the washer is used to connect two hollow parts that allow the passage of a fluid therethrough. Here the AN washer is not necessarily being used to space the two parts, but, rather to seal the mating surfaces of the two parts so that fluid contained within the hollow parts, usually under pressure, does not escape to the outside. An example of this use is a connection of a fluid carrying hose to a stationary part.

AN washer are readily available and perform their functions quite well, one problem with AN washers that arises, particularly in repair work, is placement of the AN washer into the restricted spaces of an airframe while inserting a threaded fastener can be very difficult. Frequently, an AN washer is placed into a particular location in the airframe during the manufacture of the airplane, the fastener tightened, and other airframe parts then assembled around the parts previously assembled. This assembly procedure may be efficient and sound engineering at the time of manufacture, but it fails to consider that the part may be needed to be removed at a later date for repair of replacement. All too frequently the replacement of the part is sufficiently difficult, and the replacement of the AN washer becomes nearly impossible owing to the close confines and restricted working spaces involved in placing and holding both the AN washer and the fastener while attempting to insert the fastener through the airframe parts and the AN washer.

In some instances, conventional wisdom and manual dexterity allow a mechanic to place an AN washer in the appropriate location and hold the washer while the fastener is inserted, however, this does not always happen. In some instances, where there is insufficient space for the use of hands, a pliers or other tool can be used to hold the AN washer while the fastener is inserted, but, even this procedure has its limitations and the amount of space decreases, there reaches a point where even the thinnest pliers cannot be placed in the available space to hold the AN washer.

Existing tools and manual dexterity, have limits and all too frequently the limits are surpassed leaving a mechanic with no viable way to locate the AN washer while inserting a fastener through the fitting and the AN washer. What is needed is a simple tool for holding and inserting AN washers during fabrication and repair of aircraft.

### SUMMARY OF THE INVENTION

The invention described herein relates to a tool for holding and inserting spacer washers, and more particularly a tool for holding and inserting high precision washers as spacers or gaskets as used to assembly or repair in aircraft.

The washer insertion tool as described herein is a tool, elongate in shape having a “C” shaped ironing at its end. The opening is approximately semicircular and sized to be slightly smaller than the outside diameter of a selected size of an AN washer. The semicircular opening terminates in a pair of opposing ears for grasping the AN washer and there may be a deformation controlling slot formed between the ears and extending into the handle. The tool may be single ended, or may have semicircular washer receiving openings formed on each end, each opening being sized to receive a different sized AN washer.

The tool is designed so that a user may easily and readily insert an AN washer into an appropriately sized washer receiving opening and use the tool to hold the washer in place while the washer is inserted in to the proper location in the airframe and the fastener inserted and thus with the AN washer retained in the desired location, the tool may be removed from the washer and the fastener tightened.

While the AN washers are available in generally two thicknesses, thick and thin, the tool is constructed to have a thickness to accommodate the thick washers and can still be used for holding the thin washers. The tool is constructed in several sizes to fit the different standard sizes of the AN washers. A set of four double ended tools will fit all of the commonly used sizes of AN washers and a set with a greater number of tools 10 would fit all of the available AN washer sizes. The invention is a simple tool for holding and inserting AN washers during fabrication and repair of aircraft

### BRIEF DESCRIPTION OF THE DRAWINGS

FIG. 1 is a plan view of the tool shown in one of the smaller sizes.

FIG. 2 is a plan view of the tool shown in one of the larger sizes showing a washer inserted and a washer being inserted.

### DESCRIPTION OF THE PREFERRED EMBODIMENT

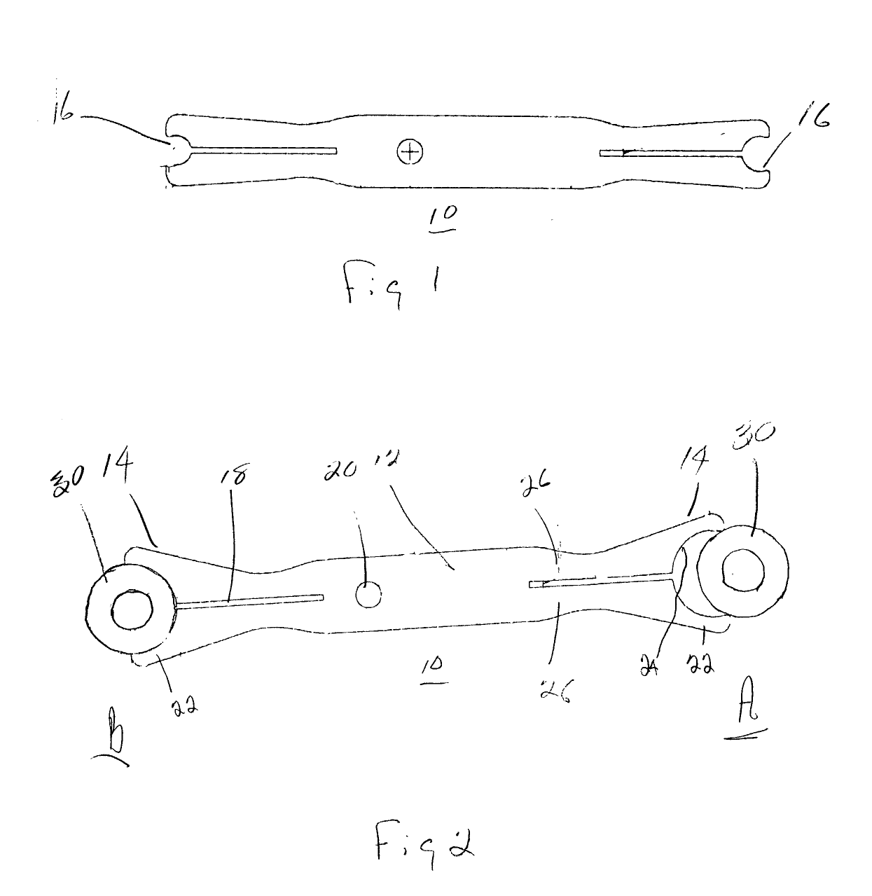

The tool 10, as shown in FIGS. 1 and 2 , consists of a handle 12 and a tool end 14. At the tool end 14 there is formed a washer receiving opening 16 sized to receive a washer 30. The tool 10, as shown in the figures has two ends 14, each end being sized to accept a different diameter AN washer 30, preferably, one size and the next size larger or smaller washer 30.1 the tool further has a hole 20 located centrally therein for hanging the tool for storage. It is understood, however, that the tool 10 may be constructed having only one tool end 14 in some applications.

Each tool end 14 has an approximately semi-circular washer receiving opening 16 formed terminally thereon. The washer receiving opening 16 is further composed of a pair of ears 22. Each ear 22 has an arcuate segment 24 formed on the inner periphery. The arcuate segment 24 has a radius to fir a selected size of AN washer 30 and hold the washer 30 about the periphery of the washer 30. Taken together the pair of ears 22 will form a semi-circular opening of slightly more than 180 degrees and slightly smaller than the outside diameter of the selected AN washer 30. As shown in FIG. 2, the right side tool end 14, labeled “A” for convenience, is shown with a washer 30 being inserted. The ears 22 of the tool end 14 for a washer receiving opening 16 that is inadequate in size to receive the washer 30 without deformation of the tool 10. Thus the slight deformation of the ears 22 of on the tool 14 will secure and hold the washer 30 placed therein.

The flexibility of the tool end 14 is controlled and enhanced by forming a slot 18 between the pair of tool end 16 ears 22. The slot 18 cooperates with the web 26 of the tool end 14 to define the flexibility of the tool 10 so that the ears 22 may be urged slightly apart to allow the insertion and retention of a washer 30. As shown also in FIG. 2, with the opposite or left end 14 of the tool 10, labeled “B” for convenience, a washer 30 has been inserted into the washer receiving opening 16 and is retained therein by the tension caused by the deformation of the tool end 16. Thus, the washer is gripped by the pair of ears 22 held adjacent the outer periphery of the washer 30. It is noted that the inner periphery 24 of the ears 22 has a radius sized to closely conform to the radius of the outer surface of the washer 30.

The tool 10 is sized to comfortably fit in an average sized hand of a user and may be approximately 6.25 inches in length. The length of the tool 10 is not important to the function of the tool 10 and may be varied within a large range to include very long tools 10 for reaching into otherwise inaccessible locations or very short tools 10 to reach into very small cramped spaces. Likewise, the handle 12 of the tool 10 has been described as simply a straight handle 12 for convenience, it being understood that the handle 12 may be bent, circular in cross section, or any other easily fabricated shape to provide for ease of operation. The handle 12 may be manufactured in other shapes both straight and bent to accommodate a particular application.

The tool 10 may be constructed from any suitable materials such as metals, rigid plastics, or glass filled plastic and is preferably constructed from type 301 full hard stainless steel. The tool 10 or at least the tool ends 14 may be of any suitable thickness and are preferably no thicker than the thickness of a “thick” AN washer or approximately 0.043 inch. The above construction has been optimized for the use of type 301 stainless steel in fabrication it is, however, understood that a choice of a different material for fabrication may require changes in some of the parameters of fabrication. For example, fabricating the tool 10 from rigid plastic may requite that the slot 18 extend a different distance from the washer receiving opening 16 into the tool end 14 and handle 12, increasing the width of the web 26, or altering the cross-section of the web 26 or some combination of the previously enumerated changes to provide sufficient rigidity so that the ears 22 will have the proper stiffness to allow the selective insertion and retention of a washer 30 while still allowing the removal of the tool 10 from the washer when desired.

While the preferred embodiment of the tool 10 is specially adapted and sized to hold and place AN washers 30, it is understood that the use of the tool 10 is equally applicable to the holding and placing other standard sized washers 30.

In its use, a user will select a tool 10 having the proper sized tool end 14 to receive an AN washer 30. The AN washer 30 is then placed into the washer receiving opening 16 by setting the washer 30 in place and urging the washer 30 between the ears 22 of the tool 10 thereby slightly deforming the tool end 14 through the webs 26 so that the ears 22 of the tool 10 have captured the washer 30 and retain the washer 30 for use. At this point, the tool 10 is used as a handle for the washer 30.

The user then takes the tool 10 with the retained washer 30 to the location where the washer 30 is to be inserted. The tool 10 is used to place the washer 30 into the desired location, generally, between two aircraft parts that will be held together using a conventional threaded fastener such as a bolt. The parts are placed in their desired location and the washer 30 is located between the two parts to allow a fastener to be passed through the first part, the washer 30, and into second part. With a threaded fastener, the fastener may then be rotated to start the threads of the fastener into the threads of the second part.

When the tool 10 is being used to insert a “thick” washer 30 and there is sufficient space for the handle 12 to extend orthogonal to the fastener the fastener may then be rotated and tightened to the appropriate torque and the tool 10 is removed by merely pulling the tool 10 from the washer 30, slightly deforming the webs 26 of the tool end 14 to allow the ears 22 to move slightly apart and release the washer 30.

When the tool 10 is used to insert a “thin” washer 30 or when the amount of space available to the user is severely restricted so that the tool 10 cannot be extended orthogonally from the fastener a slightly different procedure must be followed to allow removal of the tool 10. The tool 10 must be removed before the fastener is tightened. This procedure may be used with a “thick” washer 30 and must be used with a “thin” washer 30 to prevent the tool from being trapped between the first part and the second part. In a restricted space this procedure must be also used to remove the tool 10 before the handle 12 of the tool 10 abuts and interferes with other parts of the airframe and prevents the proper tightening of the fastener. After removal of the tool 10, the fastener may be completely tightened to the appropriate torque.

Although the present invention has been described with reference to preferred embodiments, workers skilled in the art will recognize changes may be made in the form and detail without departing from the spirit and scope of the invention.

What is claimed is

1. a tool comprising:
a. means for holding the tool;
b. means for selectively holding a standard sized washer, the selective holding and releasing means being approximately the thickness of the washer.

2. The invention as described in claim 1 wherein the means for holding the tool comprises a handle.

3. The invention as described in claim 2 wherein the thickness of the handle approximates the thickness of the washer.

4. The invention as described in claim 2 wherein the handle is planer in shape and has deformable webs.

5. The invention as described in claim 4 wherein the thickness of the deformable webs approximates the thickness of the washer.

6. The invention as described in claim 2 wherein the handle is elongate.

7. The invention as described in claim 1 wherein the means for selective holding further comprises a planer first end of the tool having a pair of opposing ears formed thereon.

8. The invention as described in claim 7 wherein the thickness of the planer first end of the tool is approximately the thickness of the washer.

9. The invention as described in claim 7 wherein the thickness of the planer first end of the tool is approximately 0.040 to 0.042 inches.

10. The invention as described in claim 9 wherein the facing surfaces of the opposing ears are partial circles.

11. The invention as described in claim 10 wherein the partial circular inner surfaces of the opposing ears extend to a semicircle.

12. The invention as described in claim 10 wherein the partial circular inner surfaces of the opposing ears extend further than a semicircle.

13. The invention as described in claim 7 wherein the means for holding the tool further comprises a deformable web located adjacent the opposing ears.

14. The invention as described in claim 13 wherein the web further has a longitudinal slot extending along at least part of the web.

15. The invention as described in claim 14 wherein the longitudinal slot controls the deformability of the web.

16. A tool for selectively holding standard sized washers comprising:
a handle having a first end, the first end having a pair of facing ears formed facingly thereon the facing ears having a partial circular inner periphery sized to matingly abut the outer periphery of a standard sized washer; the handle first end further having a relief slot formed between the ears, the relief slot extending along the handle from the first end, the handle further having a thickness approximating the thickness of the standard sized washer.

17. The invention as described in claim 16 wherein the partial circular inner periphery forms a half circle.

18. The invention as described in claim 16 wherein the partial circular inner periphery extends slightly further than a semicircle.

19. The invention as described in claim 16 wherein the facing ears have a thickness approximating the thickness of the washers.
